(19) United States
(12) Patent Application Publication
(10) Pub. No.: US 2016/0246230 A1
(43) Pub. Date: Aug. 25, 2016

(54) IMAGE FORMING APPARATUS, FIXING DEVICE, AND IMAGE FORMING METHOD

(71) Applicant: FUJI XEROX CO., LTD., Tokyo (JP)

(72) Inventor: Shogo KAMIYA, Kanagawa (JP)

(73) Assignee: FUJI XEROX CO., LTD., Tokyo (JP)

(21) Appl. No.: 14/803,400

(22) Filed: Jul. 20, 2015

(30) Foreign Application Priority Data
Feb. 19, 2015 (JP) 2015-030205

(51) Int. Cl. G03G 15/20

(52) U.S. Cl. CPC G03G 15/2085

(57) ABSTRACT

An image forming apparatus includes an image forming unit, a rotary member, a nipping area forming member, an assisting member, and a supporting unit. The image forming unit forms an image. The rotary member rotates while in contact with a recording medium, to which the image formed by the image forming unit is transferred. The nipping area forming member forms a nipping area for nipping the recording medium between the nipping area forming member and the rotary member. The assisting member assists the recording medium to peel off the rotary member, and forms a gap between the assisting member and the rotary member. The supporting unit supports the assisting member to be movable in a direction of separating from the rotary member and a transport path used to transport the recording medium.

### CROSS-REFERENCE TO RELATED APPLICATIONS

This application is based on and claims priority under 35 USC 119 from Japanese Patent Application No. 2015-030205 filed Feb. 19, 2015.

### BACKGROUND

1. Technical Field

The present invention relates to an image forming apparatus, a fixing device, and an image forming method.

### SUMMARY

According to an aspect of the invention, there is provided an image forming apparatus including an image forming unit, a rotary member, a nipping area forming member, an assisting member, and a supporting unit. The image forming unit forms an image. The rotary member rotates while in contact with a recording medium, to which the image formed by the image forming unit is transferred. The nipping area forming member forms a nipping area for nipping the recording medium between the nipping area forming member and the rotary member. The assisting member assists the recording medium to peel off the rotary member and forms a gap between the assisting member and the rotary member. The supporting unit supports the assisting member to be movable in a direction of separating from the rotary member and a transport path used to transport the recording medium.

### BRIEF DESCRIPTION OF THE DRAWINGS

An exemplary embodiment of the present invention will be described in detail based on the following figures, wherein:

FIG. 1 is a diagram illustrating a schematic configuration of an image forming apparatus according to the exemplary embodiment of the invention;

FIG. 2 is a diagram illustrating a schematic configuration of a fixing device included in the image forming apparatus illustrated in FIG. 1;

FIG. 3 is a plan view illustrating a configuration of the fixing device illustrated in FIG. 2, in which a fixing roller, a fixing belt, and a peeling assisting member are attached to side plates;

FIG. 4 is a diagram illustrating the fixing device illustrated in FIG. 2 in the direction of arrow IV in FIG. 3;

FIG. 5 is a diagram illustrating the fixing roller and the peeling assisting member included in the fixing device illustrated in FIG. 2, as viewed from a left surface side;

FIG. 6 is a plan view illustrating a configuration of the fixing device illustrated in FIG. 2, in which changing members included in a changing mechanism are attached to the side plates in addition to the fixing roller, the fixing belt, and the peeling assisting member;

FIG. 7 is a diagram illustrating the fixing device illustrated in FIG. 2 in the direction of arrow VII in FIG. 6; and

FIGS. 8A to 8C are diagrams illustrating operations of the fixing device illustrated in FIG. 2, FIG. 8A being a diagram illustrating the fixing device in a state for fixing an image on plain paper, FIG. 8B being a diagram illustrating the fixing device in a state for fixing an image on thick paper, and FIG. 8C being a diagram illustrating the fixing device in a state in which force for pressing the fixing belt against the fixing roller is cancelled.

### DETAILED DESCRIPTION

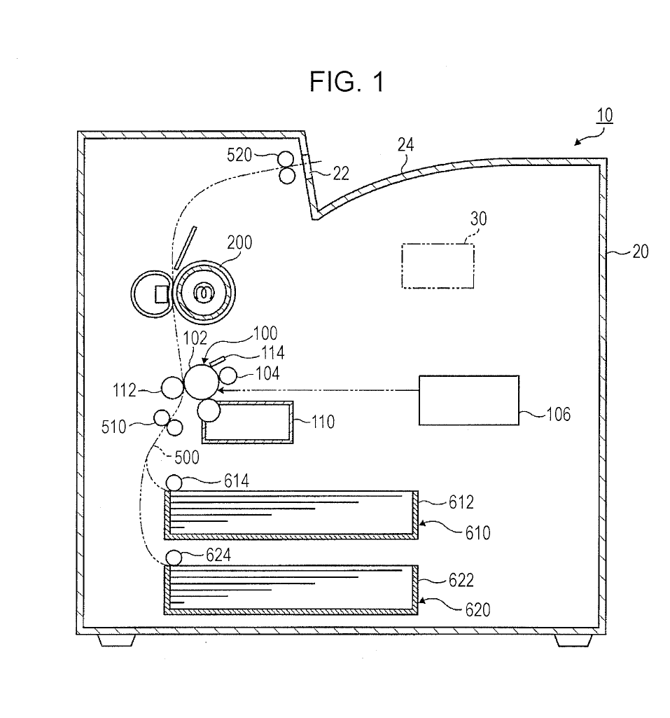

An exemplary embodiment for implementing the present invention will now be described with reference to the drawings. FIG. 1 illustrates an image forming apparatus 10 according to an exemplary embodiment of the invention. As illustrated in FIG. 1, the image forming apparatus 10 includes an image forming apparatus body 20 formed with an exit port 22 through which a recording medium is discharged. Further, an upper surface of the image forming apparatus body 20 is used as an exit unit 24 onto which the recording medium having a toner image fixed thereon is discharged. Herein, the recording medium is a medium on which an image is fixed to be recorded. Specific examples of the recording medium include sheets and envelopes of various thicknesses, for example. A case in which a sheet such as plain paper is used as the recording medium will be described below as an example.

In the image forming apparatus body 20, an image forming unit 100 is disposed which forms a toner image, that is, an image, on a sheet. The image forming unit 100 includes a photoconductor drum 102, a charging device 104, a latent image forming device 106, a developing device 110, a transfer device 112, and a cleaning device 114. The photoconductor drum 102 is used as an image carrier that carries the image. The charging device 104 uniformly charges a surface of the photoconductor drum 102. The latent image forming device 106 forms an electrostatic latent image on the surface of the photoconductor drum 102 uniformly charged by the charging device 104. The developing device 110 develops the latent image formed by the latent image forming device 106 with a developer formed of a mixture of toner and carrier, for example. The transfer device 112 transfers to a sheet a toner image formed on the surface of the photoconductor drum 102 through the development of the latent image by the developing device 110. The cleaning device 114 cleans off the toner and so forth remaining on the surface of the photoconductor drum 102 after the transfer of the toner image to the sheet by the transfer device 112.

In the image forming apparatus body 20, a fixing device 200 is further disposed which fixes on the sheet the toner image formed on the sheet by the image forming unit 100. Details of the fixing device 200 will be described later.

In the image forming apparatus body 20, sheet feed devices 610 and 620 are further disposed. The sheet feed device 610 supplies a sheet to the image forming unit 100. The sheet feed device 620 similarly supplies a sheet to the image forming unit 100. The sheet feed device 610 includes a sheet storage unit 612 that stores stacked sheets and a feeding device 614 that feeds the sheets stored in the sheet storage unit 612 to a later-described transport path 500. Further, the sheet feed device 620 includes a sheet storage unit 622 that stores stacked sheets and a feeding device 624 that feeds the sheets stored in the sheet storage unit 622 to the later-described transport path 500.

Each of the sheet storage units 612 and 622 is capable of storing different types of sheets in different sizes. The different types of sheets may be different in thickness, for example. When fixing toner images on different types of sheets different in thickness, for example, it is desirable to set a fixing condition, under which the fixing device 200 fixes a toner image on a sheet, to be different between the different types of sheets.

In the image forming apparatus body 20, the transport path 500 for transporting a sheet is further formed. The sheet feed device 620, the sheet feed device 610, registration rollers 510, the transfer device 112, the photoconductor drum 102, the fixing device 200, and exit rollers 520 are disposed along the transport path 500 in this order from the upstream side in a transport direction of the sheet on the transport path 500.

The registration rollers 510 temporarily stop the movement of a leading edge portion of the sheet supplied from one of the sheet feed devices 610 and 620, and resume the movement of the leading edge portion of the sheet toward a transfer area formed by the photoconductor drum 102 and the transfer device 112 in synchronization with the formation of the toner image on the surface of the photoconductor drum 102.

The transfer device 112 is applied with a transfer bias, and electrostatically transfers the toner image formed on the surface of the photoconductor drum 102 onto the sheet.

The exit rollers 520 discharge the sheet having the toner image fixed thereon by the fixing device 200 toward the exit unit 24 through the exit port 22.

Further, an operation panel 30 used as an operation unit for operating the image forming apparatus 10 is attached to, for example, a front surface of the image forming apparatus body 20. The operation panel 30 is used to input information related to image formation, such as an input by an operator as to which one of the sheet feed devices 610 and 620 should be caused to supply the sheet, for example.

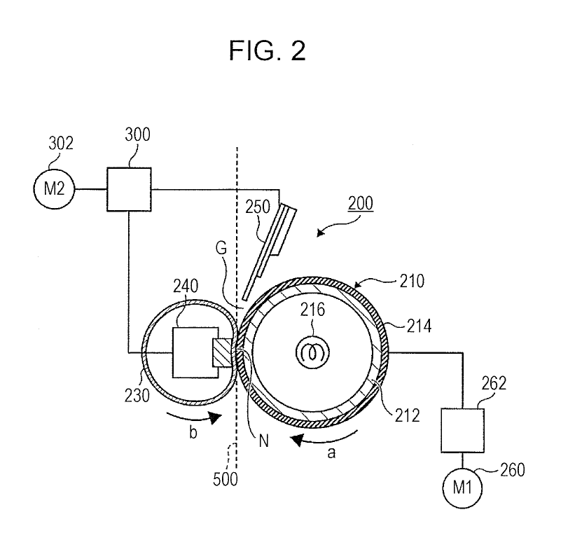

FIG. 2 illustrates a schematic configuration of the fixing device 200. As illustrated in FIG. 2, the fixing device 200 includes a fixing roller 210, a fixing belt 230, a peeling assisting member 250, and a changing mechanism 300. The fixing roller 210 is used as a rotary member that rotates while in contact with the sheet, to which the toner image formed by the image forming unit 100 (see FIG. 1) is transferred. Further, the fixing roller 210 is connected to a drive source 260, such as a motor, for example, via a drive transmission mechanism 262, such as a gear train, for example, and is rotated in the direction of arrow a illustrated in FIG. 2 by drive transmitted from the drive source 260.

The fixing roller 210 has a cylindrical shape, and includes a core rod member 212 made of aluminum, for example, and an elastic layer 214 made of rubber, for example, and covering the core rod member 212. A surface of the elastic layer 214 is coated with and protected by a resin or the like. The resin coating also makes it easy for the sheet having the toner image formed thereon to peel off a surface of the fixing roller 210.

The fixing device 200 further includes a heat source 216, which may be a halogen lamp, for example. The heat source 216 is disposed in a hollow space inside the core rod member 212.

The fixing roller 210 includes the elastic layer 214, as described above, and thus is compressed as the fixing belt 230 and so forth are pressed against the fixing roller 210, and expands as the pressed fixing belt 230 and so forth separate from the fixing roller 210. Further, the fixing roller 210 is compressed as the force for pressing the fixing belt 230 and so forth against the fixing roller 210 is increased, and expands as the force for pressing the fixing belt 230 and so forth against the fixing roller 210 is reduced.

The fixing belt 230 is used as a nipping area forming member that forms a nip part N, which is a nipping area for nipping the sheet, between the fixing belt 230 and the fixing roller 210. The fixing belt 230 is an endless band-shaped member made of a flexible material, and is rotated in the direction of arrow b illustrated in FIG. 2 by the rotation of the fixing roller 210. Further, the fixing belt 230 is rotatably supported and pressed rightward (rightward in FIGS. 1 and 2) against the fixing roller 210 by a fixing belt supporting member 240 disposed inside the fixing belt 230. The fixing belt supporting member 240 is one of members forming a nipping area forming member supporting unit.

The fixing belt 230 may be replaced by a pad member, for example, which serves as the nipping area forming member that forms the nipping area (the nip part N) between the nipping area forming member and the fixing roller 210. As described above, the nipping area forming member may or may not be moved by the rotation of the fixing roller 210.

The peeling assisting member 250 is used as an assisting member for assisting the sheet to peel off the surface of the fixing roller 210, and forms a gap G between the peeling assisting member 250 and the fixing roller 210. When the toner image is formed on the sheet, the toner image is not formed on a leading edge portion in the transport direction of the sheet in many cases. Further, a part of the leading edge portion of the sheet not formed with the toner image (hereinafter referred to as the leading edge margin) is unlikely to adhere to the fixing roller 210, and thus is often separated from the fixing roller 210.

The peeling assisting member 250 assists the sheet to peel off the fixing roller 210 by guiding the leading edge margin separated from the fixing roller 210 onto the peeling assisting member 250. The peeling assisting member 250 is thus capable of guiding and assisting the sheet to peel off the fixing roller 210 despite the gap G formed between the peeling assisting member 250 and the fixing roller 210. Further, due to the gap G formed between the peeling assisting member 250 and the fixing roller 210, the peeling assisting member 250 does not come into contact with and degrade the surface of the fixing roller 210.

The changing mechanism 300 is used as a changing unit that changes the force for pressing the fixing belt 230 against the fixing roller 210. Further, the changing mechanism 300 is connected to a drive source 302, such as a motor, for example, and is driven by drive transmitted from the drive source 302. The changing mechanism 300 may be operated by direction operation by the operator instead of the use of the drive source 302.

The changing mechanism 300 is further connected to the fixing belt supporting member 240 and the peeling assisting member 250. Further, the peeling assisting member 250 moves to change the size of the gap G in accordance with the change by the changing mechanism 300 of the force for pressing the fixing belt 230 against the fixing roller 210. More specifically, the peeling assisting member 250 moves in a direction of approaching the fixing roller 210 in accordance with an increase by the changing mechanism 300 of the force for pressing the fixing belt 230 against the fixing roller 210. In this case, the fixing roller 210 is compressed owing to the increase in the force for pressing the fixing belt 230 against the fixing roller 210, raising the possibility that the gap G may exceed a desirable value. Since the peeling assisting member 250 moves in the direction of approaching the fixing roller 210, however, the gap G is unlikely to exceed the desirable value.

Further, the peeling assisting member 250 moves in a direction of separating from the fixing roller 210 and the transport path 500 in accordance with a reduction by the changing mechanism 300 of the force for pressing the fixing belt 230 against the fixing roller 210. In this case, the fixing roller 210 expands owing to the reduction in the force for pressing the fixing belt 230 against the fixing roller 210, raising the possibility that the peeling assisting member 250 may come into contact with the fixing roller 210. The peeling assisting member 250, however, moves in the direction of separating from the fixing roller 210, and thus does not come into contact with the fixing roller 210.

Further, if the peeling assisting member 250 moves toward the transport path 500, there arises the possibility that the peeling assisting member 250 may interfere with the transport path 500 and obstruct the transport of the sheet on the transport path 500. In the present image forming apparatus 10, however, the peeling assisting member 250 moves in the direction of separating from the transport path 500, and thus does not obstruct the transport of the sheet on the transport path 500.

Herein, the reduction of the force for pressing the fixing belt 230 against the fixing roller 210 includes the cancellation of the force for pressing the fixing belt 230 against the fixing roller 210. As described above, in the present image forming apparatus 10, the peeling assisting member 250 moves in the direction of separating from the fixing roller 210 and the transport path 500 in accordance with the expansion of the fixing roller 210.

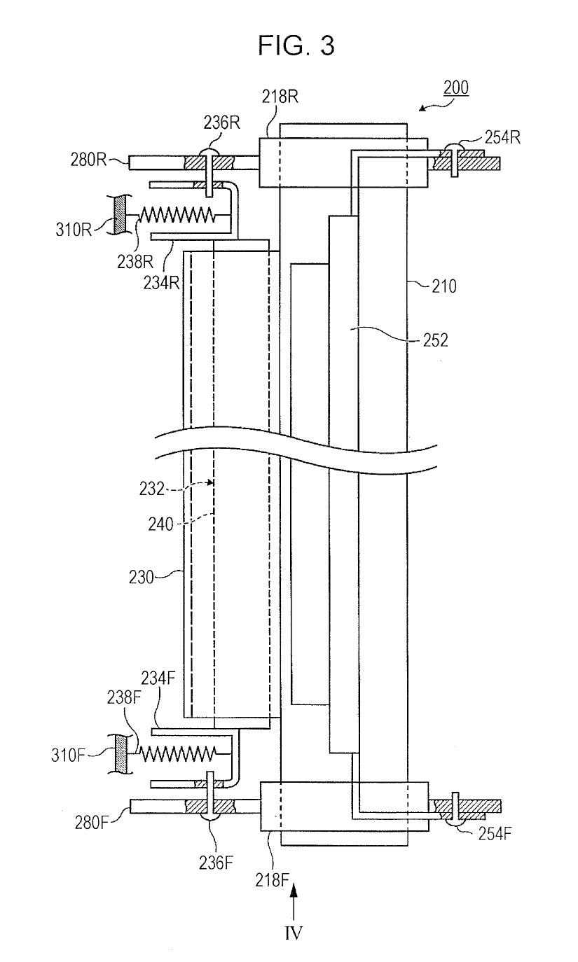

The fixing roller 210, the fixing belt 230, and the peeling assisting member 250 described above are supported by later-described support side plates 280F and 280R included in the fixing device 200 (see FIG. 3). Details of the changing mechanism 300 will be described later.

FIG. 3 illustrates the support side plates 280F and 280R included in the fixing device 200, and also illustrate a configuration in which the fixing roller 210, the fixing belt 230, and the peeling assisting member 250 are supported by the support side plates 280F and 280R.

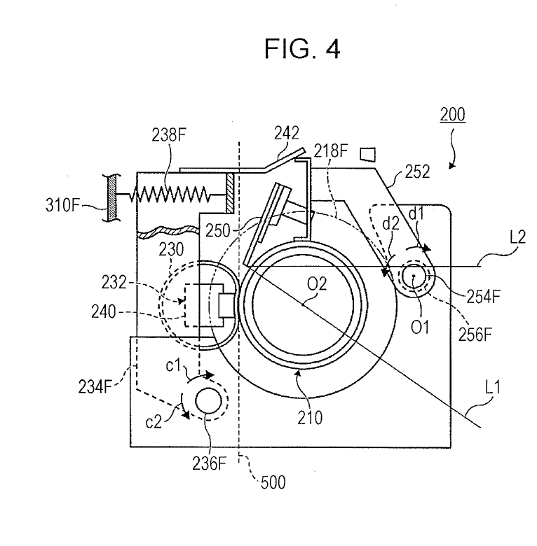

As illustrated in FIGS. 3 and 4, a shaft bearing 218F is attached to an end portion of the fixing roller 210 on the front side (the lower side in FIG. 3 and the near side of paper in FIG. 4), and a shaft bearing 218R is attached to an end portion of the fixing roller 210 on the rear side (the upper side in FIG. 3 and the depth side of paper in FIG. 4). Further, the shaft bearing 218F is fixed to the support side plate 280F, and the shaft bearing 218R is fixed to the support side plate 280R. Thereby, the fixing roller 210 is installed to be rotatable relative to the support side plates 280F and 280R. In FIG. 4, a part of the shaft bearing 218F is indicated by an imaginary line (dashed double-dotted line) to clearly illustrate members disposed behind the shaft bearing 218F.

The fixing belt 230 is supported by a fixing belt supporting unit 232, which is used as the nipping area forming member supporting unit that supports the fixing belt 230, to be swingable relative to the support side plates 280F and 280R. The fixing belt supporting unit 232 includes the aforementioned fixing belt supporting member 240 (see also FIG. 2), swing members 234F and 234R, and a regulation plate 242.

In the fixing belt supporting unit 232, a front end portion of the fixing belt supporting member 240 disposed inside the fixing belt 230 is fixed to the swing member 234F, and a rear end portion of the fixing belt supporting member 240 is fixed to the swing member 234R. Further, the swing member 234F is supported by a shaft member 236F to be rotatable relative to the support side plate 280F in the directions of arrows c1 and c2 illustrated in FIG. 4. The swing member 234R is supported by a shaft member 236R to be rotatable relative to the support side plate 280R in the directions of arrows c1 and c2.

With the above-described structure, the fixing belt 230 is supported to be rotatable and swingable relative to the support side plates 280F and 280R around the shaft members 236F and 236R in the directions of arrows c1 and c2 illustrated in FIG. 4 integrally with the fixing belt supporting unit 232.

The regulation plate 242 has a front side attached to an upper portion of the swing member 234F, a rear side attached to an upper portion of the swing member 234R, and a right end portion projecting toward a later-described supporting member 252. The regulation plate 242 comes into contact with and stops the supporting member 252 to regulate the position of the supporting member 252. Although the regulation plate 242 is illustrated in FIG. 4, the illustration of the regulation plate 242 is omitted in FIG. 3 for convenience of illustration.

The swing member 234F is attached with one end portion of a biasing member 238F formed of an elastic body, such as a coil spring, for example, and the other end portion of the biasing member 238F is attached to a later-described changing member 310F. The swing member 234R is attached with one end portion of a biasing member 238R formed of an elastic body, such as a coil spring, for example, similarly to the biasing member 238F, and the other end portion of the biasing member 238R is attached to a later-described changing member 310R. The fixing belt 230 is biased by the biasing members 238F and 238R to rotate in the direction of arrow c1 around the shaft members 236F and 236R integrally with the fixing belt supporting unit 232. Further, biased by the biasing members 238F and 238R, the fixing belt 230 is pressed against the fixing roller 210.

As described above, the fixing belt supporting unit 232 used as the nipping area forming member supporting unit is biased in the direction in which the fixing belt 230 used as the nipping area forming member is pressed against the fixing roller 210 used as the rotary member.

The peeling assisting member 250 is supported by the supporting member 252, which is used as a supporting unit and also as an assisting member supporting member included in the supporting unit. The peeling assisting member 250 and the supporting member 252 are supported to be integrally swingable and rotatable relative to the support side plates 280F and 280R. More specifically, a front side of the supporting member 252 is supported by a shaft member 254F to be rotatable relative to the support side plate 280F in the directions of arrows d1 and d2 illustrated in FIG. 4, and a rear side of the supporting member 252 is supported by a shaft member 254R to be rotatable relative to the support side plate 280R in the directions of arrows d1 and d2 illustrated in FIG. 4.

Further, the front side of the supporting member 252 is attached with a biasing member 256F formed of an elastic body, such as a torsion spring, for example, and the rear side of the supporting member 252 is attached with a biasing member 256R (not illustrated) formed of an elastic body, such as a torsion spring, for example, similarly to the biasing member 256F. Further, the supporting member 252 is biased by the biasing members 256F and 256R to rotate around the shaft members 254F and 254R in the direction of arrow d1. The peeling assisting member 250 is thus biased to move in the direction of separating from the fixing roller 210 integrally with the supporting member 252.

Further, the position of the supporting member 252 is regulated by the regulation plate 242 of the fixing belt supporting unit 232. More specifically, the supporting member 252 comes into contact with the lower surface of the regulation plate 242 to be stopped against the biasing of the biasing members 256F and 256R. With the position of the supporting member 252 regulated by the regulation plate 242, the position of the peeling assisting member 250 is regulated.

Herein, when O1 represents the rotation center of the peeling assisting member 250 and the supporting member 252, O2 represents the rotation center of the fixing roller 210, and L1 represents a line connecting the rotation center O2 and an end portion of the peeling assisting member 250 on the side of the fixing roller 210, the rotation center O1 is located downstream of the line L1 in the transport direction in which the sheet is transported. When the supporting member 252 rotates in the direction of arrow d1, therefore, the peeling assisting member 250 moves in the direction of separating from the fixing roller 210, unlike a case in which the rotation center O1 is located upstream of the line L1.

Further, the rotation center O1 is located upstream in the sheet transport direction of the end portion of the peeling assisting member 250 on the side of the fixing roller 210, that is, upstream in the sheet transport direction of a line L2 illustrated in FIG. 4. When the supporting member 252 rotates in the direction of arrow d1, therefore, the peeling assisting member 250 moves in the direction of separating from the transport path 500, unlike a case in which the rotation center O1 is located downstream of the line L2.

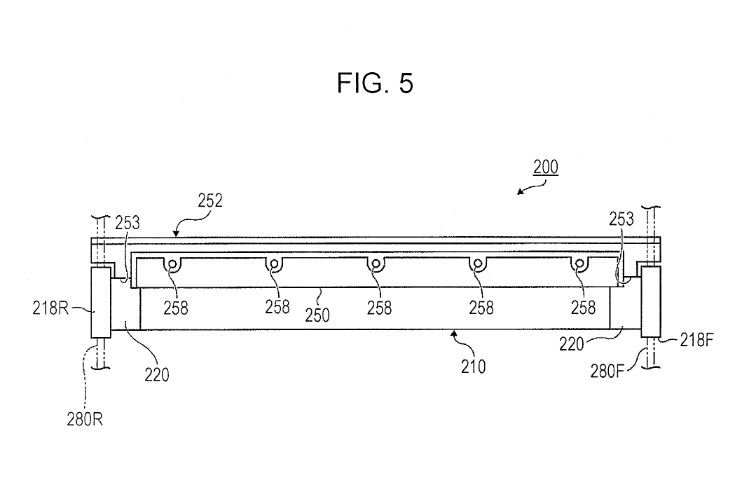

FIG. 5 illustrates the fixing roller 210, the peeling assisting member 250, and the supporting member 252, as viewed from a left surface side. As illustrated in FIG. 5, the peeling assisting member 250 is attached to the supporting member 252 with plural, such as five, for example, fasteners 258 aligned in the longitudinal direction of the peeling assisting member 250 (the horizontal direction in FIG. 5). The fasteners 258 may be screws, for example. With the fasteners 258 adjusted, the gap G (see FIG. 2) between the peeling assisting member 250 and the fixing roller 210 is adjusted at respective positions of the fasteners 258 in the longitudinal direction.

Further, as illustrated in FIG. 5, the supporting member 252 has end portions 253 respectively in contact with areas 220, which are located at opposite ends of the fixing roller 210 and do not come into contact with the sheet. Accordingly, the supporting member 252 and the peeling assisting member 250 are accurately positioned relative to the fixing roller 210. Instead of the configuration in which the end portions 253 are placed in contact with the areas 220, the front end portion 253 may be placed in contact with the shaft bearing 218F, and the rear end portion 253 may be placed in contact with the shaft bearing 218R.

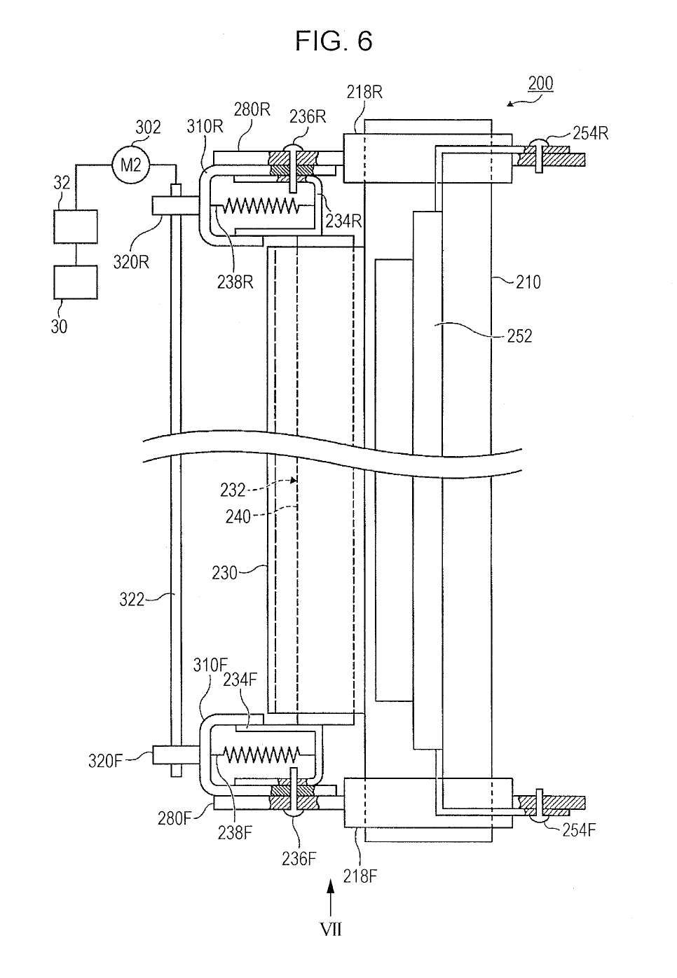

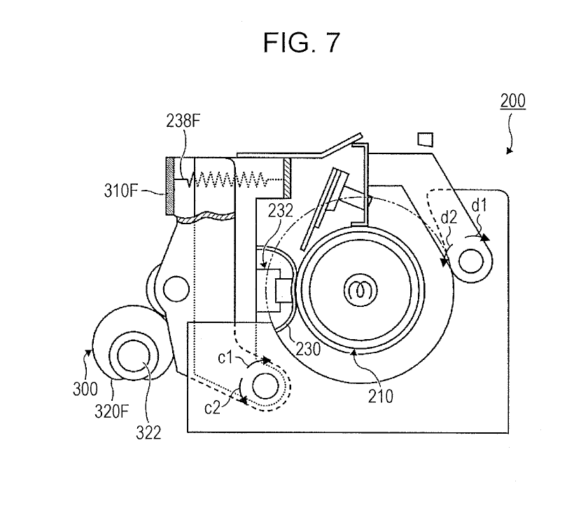

FIGS. 6 and 7 illustrate the changing mechanism 300. As illustrated in FIGS. 6 and 7, the changing mechanism 300 includes the aforementioned changing members 310F and 310R (see also FIG. 3) and cam members 320F and 320R.

The changing member 310F is supported by the shaft member 236F to be rotatable and swingable relative to the support side plate 280F in the directions of arrows c1 and c2 illustrated in FIG. 7. The changing member 310R is supported by the shaft member 236R to be rotatable and swingable relative to the support side plate 280R in the directions of arrows c1 and c2 illustrated in FIG. 7. Further, as described above, the changing member 310F is connected to the other end portion of the biasing member 238F, the one end portion of which is connected to the swing member 234F. Further, as described above, the changing member 310R is connected to the other end portion of the biasing member 238R, the one end portion of which is connected to the swing member 234R.

The cam members 320F and 320R are connected by a connecting shaft 322. As the connecting shaft 322 is rotated by the drive transmitted from the drive source 302, the cam members 320F and 320R rotate at the same phase integrally with the connecting shaft 322. Further, the cam member 320F is in contact with and presses the changing member 310F in a direction of rotating the changing member 310F around the shaft member 236F in the direction of arrow c1 against the biasing of the biasing member 238F. Further, the cam member 320R is in contact with and presses the changing member 310R around the shaft member 236R in a direction of rotating the changing member 310R in the direction of arrow c1 against the biasing of the biasing member 238R.

If the changing members 310F and 310R rotate in the direction of arrow d1 in accordance with the operation of the cam members 320F and 320R, the biasing members 238F and 238R deform to contract. Thereby, the force for biasing the fixing belt supporting unit 232 to rotate in the direction of arrow c1 is increased, and the force for rotating the fixing belt supporting unit 232 in the direction of arrow c1 is increased. Consequently, the force for pressing the fixing belt 230 against the fixing roller 210 is increased.

Meanwhile, if the changing members 310F and 310R rotate in the direction of arrow d2 in accordance with the operation of the cam members 320F and 320R, the biasing members 238F and 238R deform to expand. Thereby, the force for biasing the fixing belt supporting unit 232 to rotate in the direction of arrow c1 is reduced, and the force for rotating the fixing belt supporting unit 232 in the direction of arrow c1 is reduced. Consequently, the force for pressing the fixing belt 230 against the fixing roller 210 is reduced.

The phase between the cam members 320F and 320R is controlled by a controller 32 in accordance with the input from the operation panel 30. That is, in accordance with the thickness of the sheet stored in the sheet storage unit 612 or 622 and specified by the operation of the operation panel 30, the controller 32 calculates the phase between the cam members 320F and 320R to meet the fixing condition suitable for the specified sheet, and controls the drive source 302 such that the phase between the cam members 320F and 320R matches the calculated phase.

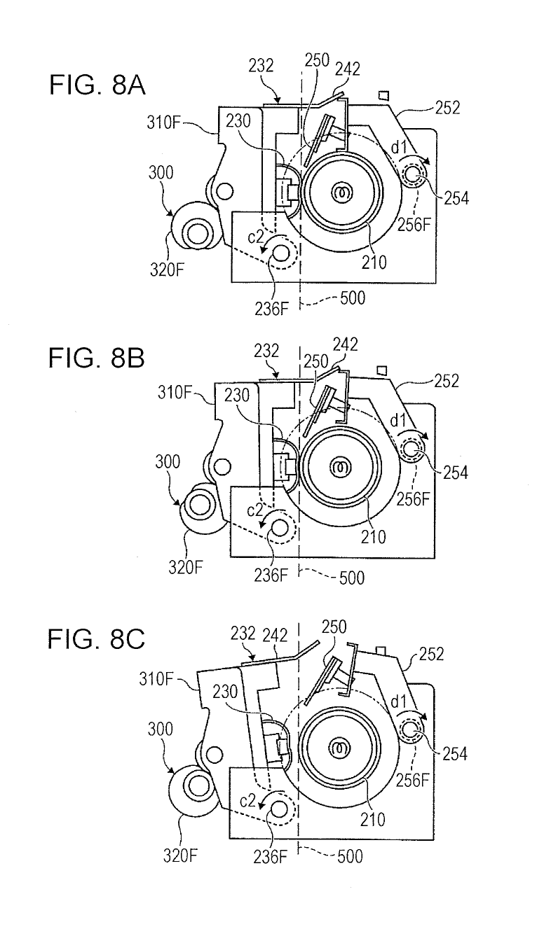

FIGS. 8A to 8C are diagrams illustrating operations of the fixing device 200. FIG. 8A is a diagram illustrating the fixing device 200 in a state for fixing a toner image on plain paper. FIG. 8B is a diagram illustrating the fixing device 200 in a state for fixing a toner image on thick paper thicker than the plain paper. FIG. 8C is a diagram illustrating the fixing device 200 in a state in which the force for pressing the fixing belt 230 against the fixing roller 210 is cancelled. To clearly illustrate the operations of the fixing device 200, FIGS. 8A to 8C exaggeratingly illustrate changes in position of the peeling assisting member 250 and the fixing belt 230 between the respective states.

In a shift from the state illustrated in FIG. 8A for fixing a toner image on plain paper to the state illustrated in FIG. 8B for fixing a toner image on thick paper, the cam members 320F and 320R rotate in accordance with the control of the controller 32. Thereby, the changing members 310F and 310R rotate in the direction of arrow c2. Accordingly, the fixing belt supporting unit 232 and the fixing belt 230 rotate in the direction of arrow c2, and the force for pressing the fixing belt 230 against the fixing roller 210 is reduced.

Further, the regulation plate 242 of the fixing belt supporting unit 232 moves, and the supporting member 252 regulated in movement by the regulation plate 242 is biased by the biasing members 256F and 256R to rotate in the direction of arrow d1. As the supporting member 252 rotates in the direction of arrow d1, the peeling assisting member 250 moves in the direction of separating from the fixing roller 210 and the transport path 500.

Also in a shift from the state illustrated in FIG. 8B for fixing a toner image on thick paper to the state illustrated in FIG. 8C, in which the force for pressing the fixing belt 230 against the fixing roller 210 is cancelled, the cam members 320F and 320R rotate in accordance with the control of the controller 32. Thereby, the changing members 310F and 310R rotate in the direction of arrow c2. Accordingly, the fixing belt supporting unit 232 and the fixing belt 230 rotate in the direction of arrow c2, and the force for pressing the fixing belt 230 against the fixing roller 210 is further reduced.

Further, the regulation plate 242 of the fixing belt supporting unit 232 moves to separate from the supporting member 252. Separated from the regulation plate 242, the supporting member 252 is biased by the biasing members 256F and 256R to rotate in the direction of arrow d1. As the supporting member 252 rotates in the direction of arrow d1, the peeling assisting member 250 further moves in the direction of separating from the fixing roller 210 and the transport path 500.

As described above, the invention is applicable to an image forming apparatus, such as a copier, a facsimile machine, or a printer, for example, and a fixing device used in such an image forming apparatus.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
an image forming unit configured to form an image;
a rotary member configured to rotate while in contact with a recording medium, to which the image formed by the image forming unit is transferred;
a nipping area forming member that forms a nipping area for nipping the recording medium between the nipping area forming member and the rotary member;
an assisting member configured to assist the recording medium to peel off the rotary member and configured to form a gap between the assisting member and the rotary member during image formation; and
a supporting unit that supports the assisting member to be movable in a separation direction, which is a direction away from the rotary member and a transport path of the recording medium.

2. The image forming apparatus according to claim 1, further comprising:
a changing unit configured to change a force for pressing the nipping area forming member against the rotary member,
wherein the supporting unit moves the assisting member in the separation direction in response to the changing unit reducing the force for pressing the nipping area forming member against the rotary member.

3. The image forming apparatus according to claim 1, wherein the supporting unit includes an assisting member supporting member that supports the assisting member, and
wherein a center of an axis around which the assisting member supporting member is configured to rotate is located downstream of a line connecting an end portion of the assisting member which is closest to the rotary member and a rotation center of the rotary member in a transporting direction and is located upstream of the end portion of the assisting member in the transporting direction.

4. The image forming apparatus according to claim 2, wherein the supporting unit includes an assisting member supporting member that supports the assisting member, and
wherein a center of an axis around which the assisting member supporting member is configured to rotate is located downstream of a line connecting an end portion of the assisting member which is closest to the rotary member and a rotation center of the rotary member in a transporting direction and is located upstream of the end portion of the assisting member in the transporting direction.

5. The image forming apparatus according to claim 1, further comprising:
a nipping area forming member supporting unit that supports the nipping area forming member and is biased to press the nipping area forming member against the rotary member,
wherein the supporting unit includes an assisting member supporting member that supports the assisting member and is biased to move in the separation direction, and
wherein the nipping area forming member supporting unit stops the assisting member supporting member from biasing the assisting member supporting member, to thereby regulate a position of the assisting member relative to the rotary member.

6. The image forming apparatus according to claim 2, further comprising:
a nipping area forming member supporting unit that supports the nipping area forming member and is biased to press the nipping area forming member against the rotary member,
wherein the supporting unit includes an assisting member supporting member that supports the assisting member and is biased to move in the separation direction, and
wherein the nipping area forming member supporting unit stops the assisting member supporting member from biasing the assisting member supporting member, to regulate a position of the assisting member relative to the rotary member.

7. A fixing device comprising:
a rotary member configured to rotate while in contact with a recording medium, to which an image formed by an image forming unit is transferred;
a nipping area forming member that forms a nipping area for nipping the recording medium between the nipping area forming member and the rotary member;
an assisting member configured to assist the recording medium to peel off the rotary member and configured to form a gap between the assisting member and the rotary member during image formation; and
a supporting unit that supports the assisting member to be movable in a separation direction, which is a direction away from the rotary member and a transport path of the recording medium.

8. (canceled)

9. The image forming apparatus according to claim 1, wherein the supporting unit is biased in the separation direction during operation of the image forming unit to form the gap between the assisting member and the rotary member

10. The fixing device according to claim 7, wherein the supporting unit is biased in the separation direction during operation of the fixing device to form the gap between the assisting member and the rotary member.
